(19) United States
(12) Patent Application Publication
(10) Pub. No.: US 2015/0321086 A1
(43) Pub. Date: Nov. 12, 2015

(54) DEVICE FOR CHILDREN'S FOOTWEAR INCLUDING WIRELESS SENSOR AND CONTROL FOR GAMES AND APPLICATIONS

(71) Applicant: Kidy Birigui Calçados Indústria e Comércio Ltda., Birigui (BR)

(72) Inventor: Ricardo GRACIA, Birigui (BR)

(21) Appl. No.: 14/644,650

(22) Filed: Mar. 11, 2015

(30) Foreign Application Priority Data
May 12, 2014 (BR) 20 2014 011370 9

(51) Int. Cl. A63F 13/216; A63F 13/212; A63F 13/235; A43B 3/00

(52) U.S. Cl. CPC A63F 13/216; A43B 3/0005; A63F 13/212; A63F 13/235

(57) ABSTRACT

A wireless sensor and control for games and applications to be applied to children's footwear, including a microchip, a 20/32 battery (A), a PVC protective capsule (B), a cover (C), screws (D) and orifices (F) for the shoestring, to be used as a wireless sensor and control for games and applications to be applied to children footwear and clothes.

### FIELD OF THE INVENTION

The present invention is directed to a wireless device for sensing and control related to software games and applications. More specifically, the invention is designed for use as a Bluetooth/Wi-Fi sensor and control for games and applications to be applied to children footwear or clothes.

### BACKGROUND OF THE INVENTION

In the market, there is a transmitting chip that is placed in the sole (from the inside) of a sneaker plus a receiver that is connected to an iPod™ (a line of portable media players and multi-purpose pocket computers designed and marketed by Apple Inc. of Cupertino, Calif.) that is attached to the arm by a brace for supplying data such as the exercise duration, the distance covered, the pace and calories while the user listens to music and jogs. After jogging, the user views a summary of the exercise and such data are sent to a web site in the Internet wherein the user can follow their performance and even compare same with that of other users all over the world, besides being able to mark in a map the ways he/she follows or mark new ways to go.

There is a movement sensor, which is a part embedded in a cellular phone that simulates the inertial movement of a small circuit that has a small metal object inside a liquid. When the user rotates the cellular phone, for example, the object inside the liquid is inert, that is, motionless, while the walls of the circuit that are integral with the structure of the cellular phone will also turn. In its turn, the object hits one of the walls on the side opposite to the rotation.

The two state-of-the-art mechanisms cited above are neither game controls nor children items.

It would be advantageous to obviate or mitigate this disadvantage.

### SUMMARY OF THE INVENTION

In one aspect of the present invention, there is provided a device for use upon a children's footwear including wireless sensor and control for games and applications, the device including a microchip providing wireless sensing and control functions; a battery providing power to the microchip; and a protective capsule for retaining the microchip and the battery, the capsule including a cover, screws for retaining the cover, and orifices for shoestring attachment.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The Bluetooth/Wi-Fi sensor and control for games and applications to be applied to children footwear and its applicability can be devised after reading the following detailed description and viewing the accompanying illustrative drawings, references to which are made in order to better elucidate the description, wherein:

FIG. 1 represents a perspective view;

FIG. 2 represents a side view;

FIG. 3 represents a rear view;

FIG. 4 represents a front view;

FIG. 5 represents an exploded view;

FIG. 6 represents the device lodged inside the footwear;

FIG. 7 represents the device attached to the shoestring;

FIG. 8 represents the device clamped to the clothes.

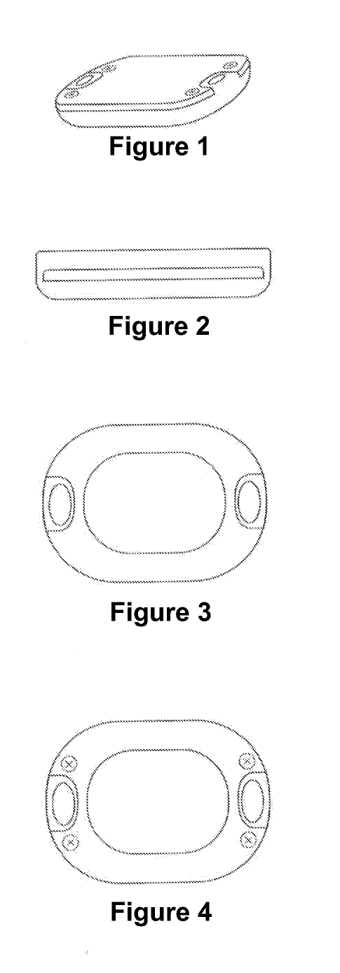

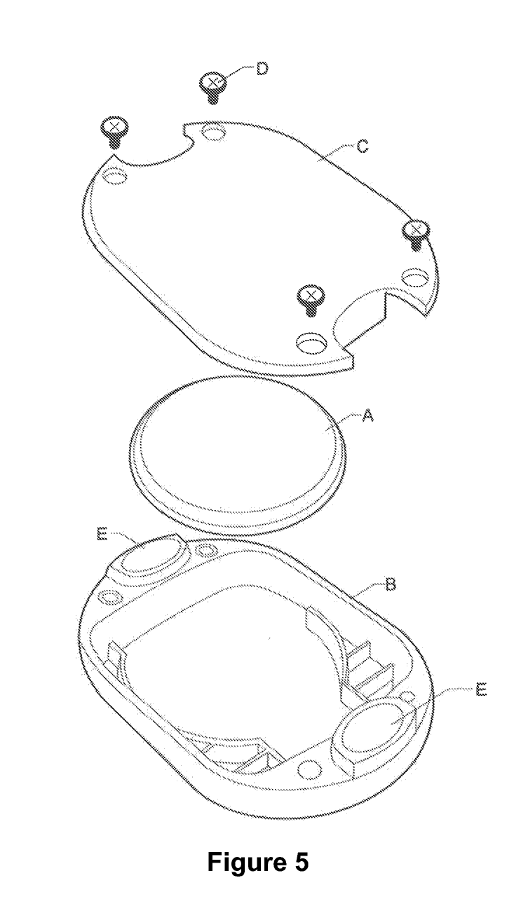

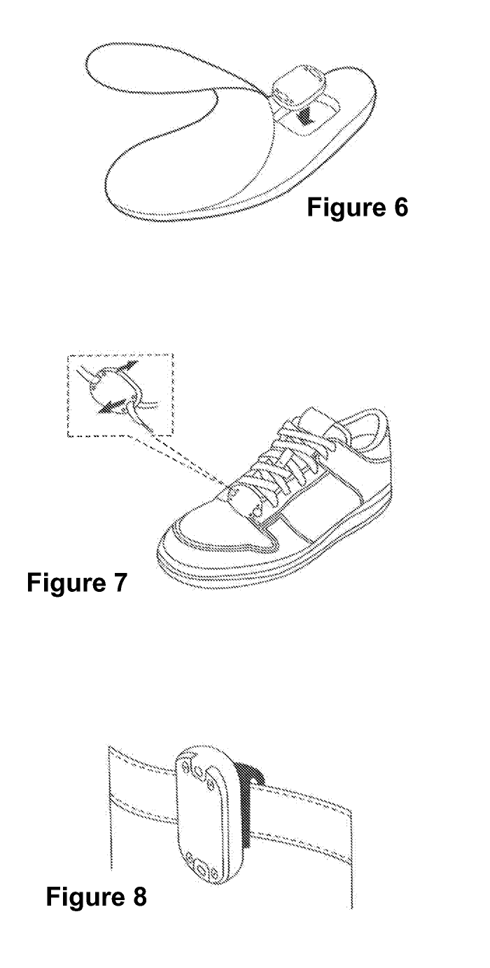

### DETAILED DESCRIPTION

After several studies and research, a wireless sensor and control for games and applications to be applied to children footwear was developed using wireless technologies including Bluetooth™ (a trademark of Bluetooth SIG, Inc. of Kirkland, Wash.) and Wi-Fi (any wireless local area network (WLAN) products that are based on the Institute of Electrical and Electronics Engineers' (IEEE) 802.11 standards and typically operating at the radio frequency band 2.5 GHz or 5 GHz). Bluetooth is a wireless technology standard for exchanging data over short distances (using short-wavelength ultra-high frequency (UHF) radio waves in the industrial, scientific and medical (ISM) radio band from 2.4 to 2.485 GHz) from fixed and mobile devices. The present invention includes as a technical benefit its interaction with novel or already existing games, the function of which is to accumulate and control (count) points.

In accordance with these illustrations and the details thereof shown, the Bluetooth/Wi-Fi sensor and control for games and applications to be applied to children footwear includes a microchip, a 20/32 battery (A), a PVC protective capsule (B), a cover (C), screws (D) and orifices (E) for the shoestring.

Thus, the Bluetooth/Wi-Fi sensor and control for games and applications to be applied to children footwear fulfills the proposed objects thoroughly by performing in a practical, efficient and safe way the function designed thereto, providing benefits inherent to its applicability, and unique and new characteristics provided with innovative basic requirements.

The device and the applications have been developed exclusively to children of both genders.

Thus, the present invention is a Wi-Fi and Bluetooth device for counting points to be used in footwear and clothes, and can be connected to personal computers (PCs), notebooks, tablets and cellular telephones having Android™ (a trademark of Google, Inc. of Menlo Park, Calif.) and Apple platforms.

The device sends a Bluetooth signal that is captured by the Wi-Fi device of cellular phones, PCs and tablets, and the signal is sent only when the device is moving, that is, while the footwear is being used.

The Bluetooth/Wi-Fi sensor and control for games and applications to be applied to children footwear is comprised of a microchip, a 20/32 battery (i.e., lithium button battery) and a PVC protective capsule.

Used as a web game control (joystick) in computers, tablets and cellular phones, free or previously paid games also can be played through the device.

The device can be lodged in the sole of the footwear, attached to the shoestring or clamped to the clothes.

Another function of the device is to record the duration the footwear is actually used, turn this duration into a score, and use said score in internet games or players communities.

The sensor can also be used with a 3G or 4G system, thus making it possible for geolocation so as to localize the footwear or the child through Google maps or other applications.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A device for use upon a children's footwear including wireless sensor and control for games and applications, said device comprising
a microchip providing wireless sensing and control functions;
a battery providing power to said microchip; and
a protective capsule for retaining said microchip and said battery, said capsule including a cover, screws for retaining said cover, and orifices for shoestring attachment.

2. The device as claimed in claim 1 wherein said microchip operates using a radio frequency selected from the group including a range from 2.4 to 2.485 GHz, 2.5 GHz, and 5 GHz.

3. The device as claimed in claim 2 wherein said microchip provides for counting points and connects said device to connected to one or more of PCs, notebooks, tablets and cellular telephones.

4. The device as claimed in claim 3 wherein said microchip connects said device to one or more of PCs, notebooks, tablets and cellular telephones only when said device is in motion.

5. The device as claimed in claim 4 wherein said device forms an Internet game controller.

6. The device as claimed in claim 5 wherein free or pre-paid games are played through said device.

7. The device as claimed in claim 6 wherein said device is lodged in a sole of a user's footwear, attached to a user's shoestring, or clamped to a user's clothing.

8. The device as claimed in claim 7 wherein said device records a duration the footwear is actually used, turns said duration time into a score, and uses said score in Internet games or players communities.

9. The device as claimed in claim 8 wherein said microchip supports mobile telecommunications technology thereby providing geolocation capability so as to locate a user of said device.
